(19) United States
(12) Patent Application Publication
(10) Pub. No.: US 2022/0371204 A1
(43) Pub. Date: Nov. 24, 2022

(54) SKIN PEELER TOOL FOR VEHICLE DOORS AND HOODS

(71) Applicant: Sylverio Malagon, Rancho Cucamonga, CA (US)

(72) Inventor: Sylverio Malagon, Rancho Cucamonga, CA (US)

(21) Appl. No.: 17/446,737

(22) Filed: Sep. 2, 2021

Related U.S. Application Data
(60) Provisional application No. 63/202,023, filed on May 24, 2021.

(51) Int. Cl. B25J 15/00; B25J 1/04

(52) U.S. Cl. CPC B25J 15/0033; B25J 1/04

(57) ABSTRACT

A peeler tool and methods of using such a tool are disclosed. The peeler tool is designed to easily remove a skin from a vehicle door frame or hood frame without damage and without the need for electrical tools. The peeler tool may include: a handle for grasping the peeler tool and a hook integral therewith. The hook is bent such that a distal end of the hook points towards the handle. Further the hook is designed to be inserted between a lip of the skin and the door frame or the hood frame to separate the lip and the door frame or the hood frame from one another.

### CROSS-REFERENCE TO RELATED APPLICATION

This application claims the benefit of priority of U.S. provisional application number 63/202,023, filed May 24, 2021, the contents of which are herein incorporated by reference.

### BACKGROUND OF THE INVENTION

The present invention relates to the peeling of a door/hood skin peeler and, more particularly, to a manual tool that is capable of peeling said door/hood skin.

Door skins and hood skins are the outer metal layers of a door and hood, respectively. Door frames and hood frames are the inner support structures of the door and hood, respectively. The term “shell” is frequently used to describe the assembly of the skin and the frame. As the outermost portion of the shell, the skin is frequently subject to damage due to various reasons, such as a vehicle accident, being struck by moving objects, etc. When this occurs, it must either be repaired (e.g., remove a dent from the skin) or replaced.

Currently, electrically powered tools (such as a grinder) are required to detach the skin edges of a door/hood skin from the rest of the door/hood frame. This removal process very frequently results in irreparable damage to the skin, meaning the cut off skin must be disposed of rather than being repaired. This process wastes material, increases the cost of fixing the vehicle door or hood, and lengthens the time for fixing the vehicle.

As can be seen, there is a need for a manual tool for removing the skin of a door/hood shell that allows the skin to be preserved and reused.

### SUMMARY OF THE INVENTION

In one aspect of the present invention, a peeler tool for removing a skin that is coupled a door frame or a hood frame is disclosed. The peeler tool includes: (1) a handle for grasping the peeler tool; and (2) a hook integral therewith, with the hook being bent such that a distal end of the hook points towards the handle, and the hook being configured to be inserted between a lip of the skin and the door frame or the hood frame to separate the lip and the door frame or the hood frame from one another.

In another aspect of the present invention, a method of removing a skin that is coupled to a door frame or a hood frame is disclosed. The method includes the steps of: (1) providing a peeler tool comprising: a handle for grasping the peeler tool; and a hook integral therewith, the hook being bent such that a distal end of the hook points towards the handle; and (2) inserting the hook between a lip of the skin and the door frame or the hood frame to separate the lip and the door frame or the hood frame from one another.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a perspective view of a first embodiment of the present invention;

FIG. 2 is a detail perspective view of the first embodiment of the present invention;

FIG. 3 is an exploded view of the first embodiment of the present invention;

FIG. 4 is a detail perspective view of the first embodiment of the present invention, shown in use with a door or hood frame;

FIG. 5 is a section view of the first embodiment of the present invention, taken along line 4-4 in FIG. 3, and illustrating the peeler tool in a position just prior to beginning to peel a skin from the door or hood frame;

FIG. 6 is another section view of the first embodiment of the present invention, similar to FIG. 4, and illustrating the peeler tool slid under a skin lip of the skin;

FIG. 7 is another section view of the first embodiment of the present invention, similar to FIG. 4, and illustrating rotation of the peeler tool to begin to peel the skin lip away from the door or hood frame;

FIG. 8 is another section view of the first embodiment of the present invention, similar to FIG. 4, and illustrating further rotation of the peeler tool to peel the skin lip such that the skin is capable of removal from the door or hood frame;

FIG. 9 is another section view of the first embodiment of the present invention, similar to FIG. 4, and illustrating the skin being pulled away from the door or hood frame;

FIG. 10 is a perspective view of a second embodiment of the present invention; and

FIG. 11 is a perspective view of the second embodiment of the present invention.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details.

Broadly, an embodiment of the present invention provides a peeler tool for removing a skin from a vehicle door frame or hood frame. The peeler tool may include: a handle/rod member for grasping the peeler tool and a hook integral therewith. The hook is bent such that a distal end of the hook points towards the handle/rod member, and the hook is configured to be inserted between a lip of the skin and the door frame or the hood frame to separate the lip and the door frame or the hood frame from one another.

Embodiments of the present invention are specifically configured for the sole intention of removal of a skin from doors and hoods of automobiles. As opposed to the prior art, it is a non-electrical tool, and does not include any moving parts (which may be more prone to failure). As mentioned above, existing tools to remove vehicle skins are electrically powered, with the most common practice being to cut the skin from the door or hood and then trash it. This is because the prior art technique of cutting away the skin causes irreparable damage to it, and a new skin must be used to replace the old one. The present invention solves this problem by peeling away the skin from the door frame instead of cutting it away.

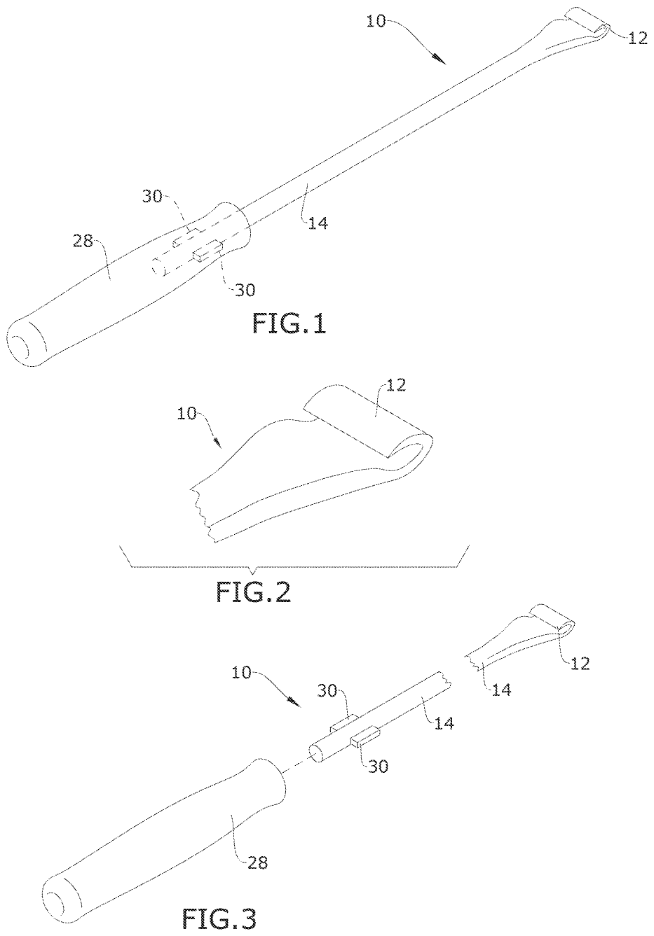

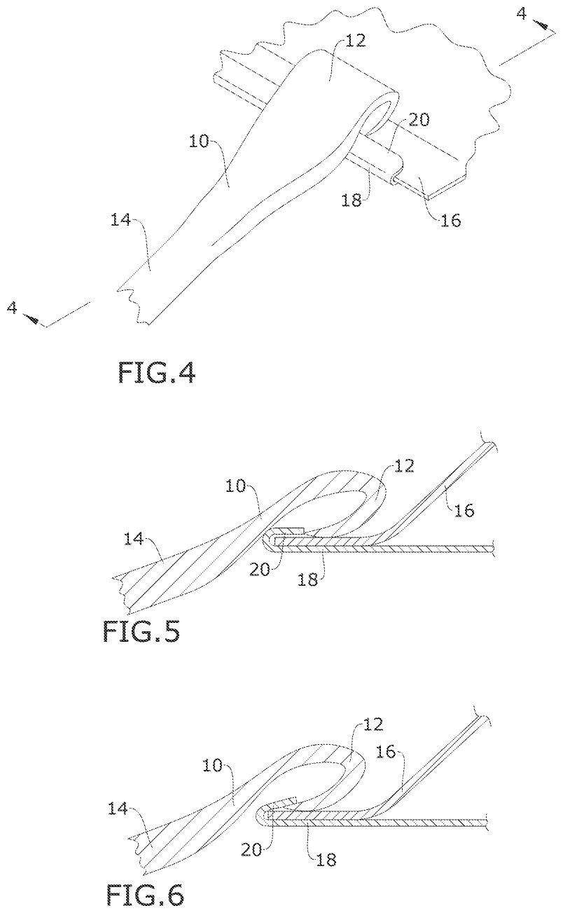

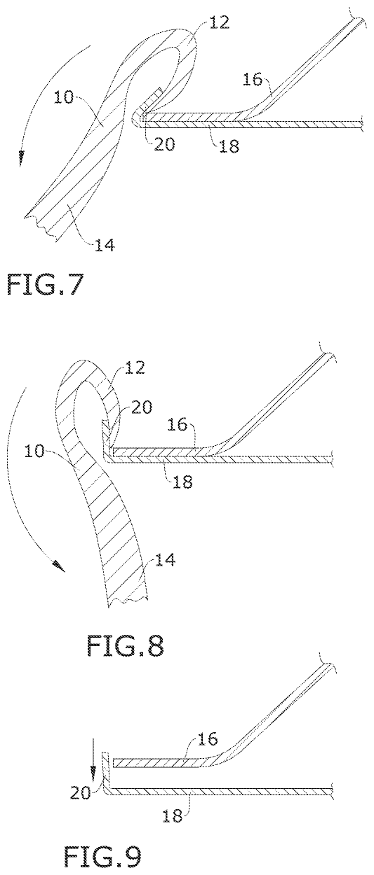

Referring to FIGS. 1-9, a first embodiment of a peeler tool 10 is shown. The peeler tool 10 is a singular piece tool and is generally composed of two primary portions, namely, a hook 12 and a rod member 14. The rod member 14 functions as an elongated handle (note that rod member 14 is also used synonymously with handle 14) and is integral with the hook 12. As shown in FIGS. 1 and 3, a grip 28 may be coupled to an end portion of the rod member 14 opposite the hook 12, with that end portion of the rod member 14 including a plurality of wings 30 for maintaining the grip 28 in place (e.g., so it cannot pull off or twisted). The peeler tool 10 may be made via various methods, such as machining. The purpose of the peeler tool 10 is to facilitate the removal (and afterward, the repair) of a skin 18 from a door or hood frame 16 of a vehicle without the need for replacement with a new skin. As shown in FIGS. 4-9, the skin 18 includes a skin lip 20 that wraps around peripheral edges of the door or hood frame 16.

As seen, for example, in FIG. 5, the hook 12 first bends upwardly before bending into the hook shape at a distal portion thereof, while additionally widening relative to the rod member 14. The distal portion terminates at a distal end that faces back towards the rod member 14 (with the hook 12, consequently, defining a substantially U-shaped design). Again, in relation to FIG. 5, a distalmost end of the hook terminates higher than a lowermost surface of the rod member 14. The hook 12 also tapers to a thinner thickness than the rod member 14, with its thinnest section being at a distal end thereof (resulting in the end of the hook being moderately sharp). This allows the distal end to more effectively slide in between the lip 20 and the peripheral edge of the frame 16.

FIGS. 5-9 show the peeler tool 10 in use. As shown from FIG. 5 to FIG. 6, the sharp distal end hooks/slides underneath the lip 20 of the skin 18 to begin to peel it away from the peripheral edge of the frame 16. This is achieved by the user abutting a pointed distal end of the hook 12 with an end of the lip 20 and the peripheral edge of the frame 16 and pulling the peeler tool away from a central/main portion of the frame 16 (and also a central/main portion of the skin 18). As shown sequentially from FIG. 6 to FIG. 7 to FIG. 8, rotation of the tool 10 counterclockwise (i.e., towards a main body portion of the skin 18) via the handle 14 (or grip 28) results in the lip 20 being pulled away from the frame 16, while remaining intact. The lip 20 may be pulled away until it forms a perpendicular or obtuse angle (i.e., can easily be detached from the frame 16, as shown in FIGS. 8-9). As the lip 20 is peeled away one section at a time, the user can move along the length of the skin 18 and frame 16 until the entirety of the lip 20 is peeled back. Once this occurs, and as shown in FIG. 9, the skin 18 may easily be pulled away from the frame 16 for removal. This process works equally well with doors and hoods of vehicles.

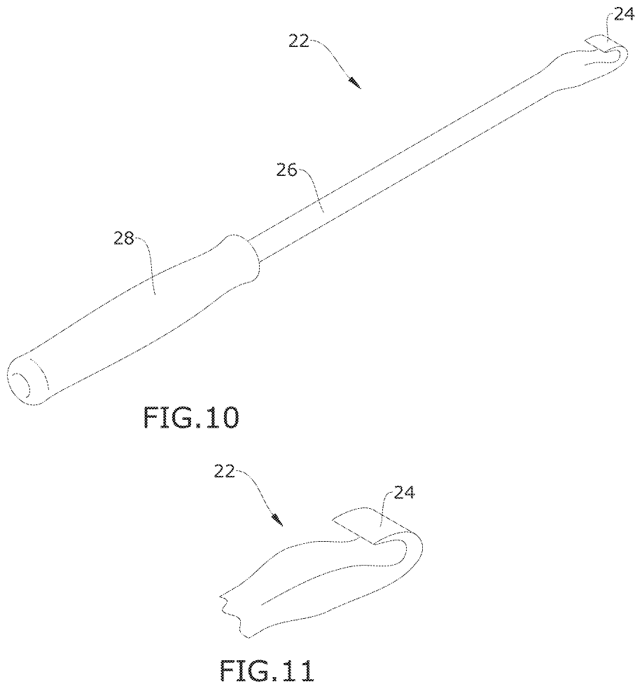

It will be appreciated that the peeler tool may be embodied in various sizes to provide superior functionality for different uses within the context of removal of the skin 18. For example, FIGS. 10-11 illustrate a second embodiment of a peeler tool 22, which also includes a thinner width hook 24 (compared to the first embodiment) and an elongated handle 26 (which also may be coupled to a grip 28). The smaller, second peeler tool 22 is preferred for corners/curves on the door/hood while the larger, first peeler tool 10 is preferred for straight portions on the door/hood. In this embodiment, a distal end of the hook 24 terminates approximately coaxial/in line with an uppermost surface of the handle 26. As with the first embodiment, the distal end also tapers to a thinner thickness than a remainder of the peeler tool 22, which also allows the distal end to slide in between the lip 20 and the peripheral edge of the frame 16 more easily. Otherwise, the second embodiment functions in a similar manner as the first embodiment and is thus not described in greater detail.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein.

While apparatuses and methods are described in terms of “comprising,” “containing,” or “including” various components or steps, the apparatuses and methods can also “consist essentially of” or “consist of” the various components and steps. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

The use of a forward slash mark “/”, as used herein, is intended to include at either item, both items, and combinations thereof. By way of example, the phrase “door/hood” refers to only the door, only the hood, or both the door and hood. In the present example, that means that the tool described herein can be used for just a door, just a hood, or both a door and a hood (e.g., removal of a door skin and hood skin on the same vehicle). Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

What is claimed is:

1. A peeler tool for removing a skin that is coupled a door frame or a hood frame, the peeler tool comprising:
a handle for grasping the peeler tool; and
a hook integral therewith, the hook being bent such that a distal end of the hook points towards the handle, and the hook being configured to be inserted between a lip of the skin and the door frame or the hood frame to separate the lip and the door frame or the hood frame from one another.

2. The peeler tool of claim 1, wherein the hook defines a substantially U-shaped profile.

3. The peeler tool of claim 1, wherein the hook tapers in thickness from a proximal end coupled to the handle to a pointed edge at the distal end.

4. The peeler tool of claim 1, wherein the hook defines a lateral width larger than that of the handle.

5. The peeler tool of claim 1, further comprising a grip coupled to the handle.

6. A method of removing a skin that is coupled to a door frame or a hood frame, the method comprising the steps of:
providing a peeler tool comprising:
a handle for grasping the peeler tool; and
a hook integral therewith, the hook being bent such that a distal end of the hook points towards the handle; and
inserting the hook between a lip of the skin and the door frame or the hood frame to separate the lip and the door frame or the hood frame from one another.

7. The method of claim 6, wherein the lip is substantially parallel with a main body portion of the skin.

8. The method of claim 6, wherein the inserting step comprises the steps of:
positioning the hook such that the hook substantially abuts a distal end of the lip and the door frame or the hood frame; and
pulling the peeler tool in a direction away a main body portion of the door frame or the vehicle frame.

9. The method of claim 6, further comprising the step of:
rotating the peeler tool to pull the lip away from the door frame or the vehicle frame.

10. The method of claim 9, further comprising the steps of:
moving the peeler tool to an adjacent section of the skin that is coupled to the door frame or the hood frame; and
repeating the inserting step and the rotating step.

11. The method of claim 6, wherein the hook defines a substantially U-shaped profile.

12. The method of claim 6, wherein the hook tapers in thickness from a proximal end coupled to the handle to a pointed edge at the distal end.

13. The method of claim 6, wherein the hook defines a lateral width larger than that of the handle.
